(19) United States
(12) Patent Application Publication
(10) Pub. No.: US 2007/0067831 A1
(43) Pub. Date: Mar. 22, 2007

(54) Communication system, and client, server and program used in such system

(75) Inventors: Makoto Matsuda, North Brunswick, NJ (US); Kiyotaka Ohara, Nagoya (JP); Kazuma Aoki, Kasugai (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/473,123

(22) Filed: Jun. 23, 2006

(30) Foreign Application Priority Data
Jun. 24, 2005 (JP) 2005-185364

(51) Int. Cl. H04L 9/32

(52) U.S. Cl. 726/5

(57) ABSTRACT

A communication system, capable of offering improved convenience to third parties having no intention of illegal use without affecting benefits of regular (authorized, registered) users, is provided. When a management server receiving an authentication request (containing authentication information inputted by the user of a client) from the client judges that the client is not a proper device based on the authentication request (authentication information), the management server requests new registration in an authentication database by transmitting a “user registration job” to the client. In a user registration server process executed by the management server upon reception of a user registration request from the client receiving the user registration job, authentication information supplied from the client can be newly registered in the authentication database.

### CROSS-REFERENCE TO RELATED APPLICATION

This application claims priority under 35 U.S.C. §119 from Japanese Patent Application No. 2005-185364, filed on Jun. 24, 2005. The entire subject matter of the application is incorporated herein by reference.

### FIELD

Aspects of the present invention relate to a communication system which is configured so that at least part of a function implementable by a client is made available through authentication by a server.

### BACKGROUND

In recent years, the need for preventing unauthorized use of devices and ensuring security is becoming more and more significant and from such viewpoints, there have been proposed devices requesting authentication of the user (to verify that the user is an authorized or registered user) at the startup of the device, etc. (see Japanese Patent Provisional Publication No. HEI 11-250013, for example).

Meanwhile, numbers of devices connectable to networks have been provided (see Japanese Patent Provisional Publication No.2001-22539, for example) and a variety of services are being supplied to users via such network-compatible devices with the prevalence of the Internet (A device receiving such services from a server will hereinafter be referred to as a “client”.). In regard to the supply of such services, how to ensure security is now recognized as a critical challenge.

For example, in a system in which a client is designed to implement its own function by receiving a service supplied from a server, a technique letting the user log in to the system through authentication by the server is generally employed. In order to prevent unauthorized use, some of such systems are configured to stop the log-in process at the point when the user failed to log in (i.e. failed to input correct information for the authentication) a prescribed times. In such cases, the authentication is impossible without carrying out a different procedure (see a Web page of eBANK Corporation “Security Measures (eBANK Corporation)” <URL: http://www.ebank.cojp/kojin/security/index.html>(referred to on May 20, 2005), for example).

Incidentally, the “function” implemented by the client can be, for example, a function of displaying information (received from the server according to the supply of a service), on a display of the client.

However, although the security achieved by the above conventional log-in process through authentication by a server is capable of preventing unauthorized use of the system by a third party, if a system is designed, for example, to prompt the user to input information for authentication (e.g. personal identification number) at the startup of a network-compatible client and to stop the startup itself at the point when the user failed to input the authentication information a prescribed times, even a third party having no intention of illegal use is totally blocked from using the system.

### SUMMARY

The aspects of the present invention are advantageous in that a communication system, capable of offering improved convenience to third parties having no intention of illegal use without affecting benefits of regular (authorized, registered) users, can be provided.

### BRIEF DESCRIPTION OF THE ACCOMPANYING DRAWINGS

FIG. 1 is a block diagram showing the overall composition of a communication system in accordance with an embodiment of the present invention.

FIG. 2 is a flow chart showing a startup process executed by an MFP (Multi Function Peripheral) of the communication system.

FIG. 3 is a flow chart showing a user change process executed by the MFP.

FIG. 4 is a flow chart showing a device process executed by the MFP.

FIG. 5 is a flow chart showing a job inquiry timer process executed by the MFP.

FIG. 6 is a flow chart showing a process (job corresponding to a service) executed by the MFP.

FIG. 7 is a flow chart showing a request handling process #1 executed by a management server of the communication system.

FIG. 8 is a flow chart showing a user registration server process executed by the management server.

FIG. 9 is a flow chart showing a request handling process #2 executed by the management server.

FIG. 10 is a flow chart showing a job execution process executed by a supply server of the communication system.

FIG. 11 is a flow chart showing a service registration process executed by the supply server.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

In accordance with an aspect of the present invention, there is provided a communication system in which at least part of a function implementable by a client is made available through authentication by a server, which is configured as below.

The server includes: an authentication judgment unit which judges whether or not authentication information on the client, contained in an authentication request transmitted from the client for requesting authentication of the client, has already been registered in an authentication database (in which authentication information to be used for authenticating the client is registered while associating the authentication information with the client) as authentication information on the client transmitting the authentication request; a permission instruction transmitting unit which transmits a permission instruction, representing permission for use of the function, to the client transmitting the authentication request when the authentication judgment unit judges that the authentication information contained in the authentication request has already been registered in the authentication database; a registration request transmitting unit which transmits a registration request, requesting new registration in the authentication database, to the client transmitting the authentication request when the authentication judgment unit judges that the authentication information contained in the authentication request has not been registered in the authentication database; and an information registering unit which registers authentication information on the client, contained in a registration application transmitted from the client receiving the registration request from the registration request transmitting unit for applying for registration, in the authentication database as authentication information on the client transmitting the registration application. The permission instruction transmitting unit is configured to transmit the permission instruction to a client on which the registration of authentication information in the authentication database has been carried out by the information registering unit.

The client includes: an information input unit which lets a user input authentication information to be used for authenticating the client; an authentication request transmitting unit which transmits the authentication request, containing the authentication information inputted through the information input unit, to the server; a registration application transmitting unit which transmits the registration application, containing authentication information inputted through the information input unit, to the server when the registration request is received from the server receiving the authentication request transmitted by the authentication request transmitting unit; and a function enabling unit which switches an operational state of the client from a function unavailable state in which at least part of the function implementable by the client is unavailable to a function available state in which the function is available when the permission instruction is received from the server receiving the authentication request transmitted by the authentication request transmitting unit or the registration application transmitted by the registration application transmitting unit.

In the communication system configured as above, when yet unregistered authentication information (contained in the authentication request) is received from a client, the server can newly register authentication information on the client in the authentication database by transmitting the registration request (requesting new registration in the authentication database) to the client and receiving the registration application containing the authentication information (transmitted from the client receiving the registration request for requesting registration of the authentication information in the authentication database). Therefore, even when the user of the client is not a “regular” user (a user who registered the authentication information existing in the authentication database), the user is allowed to use the function of the client. In this case, the function of the client is used by the non-regular user by use of the new authentication information different from the original authentication information previously registered by the regular user, and thus the use of the function of the client by the non-regular user does not infringe on benefits of the regular user.

As above, a communication system capable of offering improved convenience to third parties without affecting benefits of regular users can be provided. Here, the “third party” can include not only a person who hopes to use the client for temporary use or emergency use but also a new user of the client after the client is transferred from the previous user, and thus such a user can also take advantage of the above effects. Specifically, even when the previous user has transferred the client to the new user without deleting the authentication information, the new user can use the client with no problem, without infringing on benefits of the previous user.

Incidentally, the registration application transmitting unit of the client is a unit which transmits the registration application, containing authentication information inputted through the information input unit, to the server when the registration request is received from the server. The authentication information contained in the registration application and transmitted to the server can be the authentication information previously inputted by the user through the information input unit, authentication information inputted by the user through the information input unit at the point when the registration request is received from the server, etc.

The “authentication information” can be any information that can be used for authenticating the client, and thus not only an ID and a password assigned to the client but also information about the user of the client (user name, address, full name, phone number, credit card number, etc. of the user) can be used as the authentication information. The contents of the “authentication information” are not particularly limited as long as the authentication information can be used for the authentication of the client.

The authentication request transmitting unit of the client, as a unit transmitting the authentication request (containing the authentication information inputted through the information input unit) to the server, may be configured to transmit the authentication request each time the authentication information is inputted.

Preferably, the client further includes a coincidence judgment unit which judges whether or not the authentication information inputted through the information input unit coincides with previously registered authentication information. The authentication request transmitting unit of the client transmits the authentication request, containing the authentication information inputted through the information input unit, to the server when the coincidence judgment unit judges that the authentication information does not coincide with the previously registered authentication information. When the coincidence judgment unit judges that the authentication information inputted through the information input unit coincides with the previously registered authentication information, the function enabling unit switches the operational state of the client to the function available state without the transmission of the authentication request by the authentication request transmitting unit.

In the above configuration, the client does not transmit the authentication request to the server when the inputted authentication information coincides with the previously registered authentication information, the fiction of the client is made available without the need of communication with the server, by which an authentication load on the server and a communication load (traffic) on a network on each input of authentication information is reduced considerably.

Incidentally, when the authentication request is transmitted to the server (in the case where the inputted authentication information does not coincide with the previously registered authentication information) and thereafter the registration request is received from the server, the client may immediately transmit the registration application by including the previously inputted authentication information (i.e. the authentication information contained in the authentication request) in the registration application. With such a configuration, the user is relieved of the need of inputting the authentication information again. However, the client may also be configured to transmit the registration application by including authentication information newly inputted by the user (instead of the previously inputted authentication information) in the registration application, as described below.

Preferably, the information input unit of the client lets the user input authentication information again in the case where the coincidence judgment unit judges that the authentication information inputted through the information input unit does not coincide with the previously registered authentication information. The registration application transmitting unit of the client transmits the registration application, containing the authentication information inputted through the information input unit again, to the server.

In the above configuration, the client lets the user input authentication information again when the registration request is received from the server, by which the user is allowed to register different authentication information (different from the previously inputted authentication information) in the authentication database. Of course, the user may also input the same authentication information in the second input.

The timing of letting the user input the authentication information through the information input unit may be set arbitrarily. For example, it is desirable to configure the client to let the user input the authentication information when a prescribed operation for using at least part of the function implementable by the client is performed by the user. With such a configuration, the client authentication based on the authentication information can be conducted each time the prescribed operation (for using part of the function implementable by the client) is performed by the user.

Preferably, the information input unit of the client lets the user input the authentication information when a prescribed setting of the client has been changed.

With the above configuration, the client authentication based on the authentication information can be conducted each time the prescribed setting of the client is changed.

Preferably, the information input unit of the client lets the user input the authentication information at startup of the client.

With the above configuration, the client authentication based on the authentication information can be conducted each time the client is started up.

Incidentally, the information registering unit of the server (as a unit registering the authentication information represented by (contained in) the registration application in the authentication database while associating the authentication information with the client) may be configured, for example, to register each piece of authentication information (contained in each registration application received from the client) separately (while associating the authentication information with the client) as separate authentication information (i.e. as a separate record) without deleting the authentication information on each reception of the registration application. In this case, different pieces of authentication information can be assigned to different users of the client respectively, by which one client can be shared by a plurality of users.

Preferably, when authentication information on the client transmitting the registration application to the server in response to the registration request from the registration request transmitting unit has already been registered in the authentication database at the point of reception of the registration application from the client, the information registering unit of the server updates the already registered authentication information into authentication information represented by the received registration application.

With the above configuration, even when the user of the client does not know proper authentication information to be inputted (e.g. when the client has just been transferred to a new user), (part of) the function of the client can be implemented as before by the registration of new authentication information. Once the authentication information is updated as above, the new user can not illicitly obtain authentication information previously registered and used by the previous user nor receive a service via the client by use of the previously registered authentication information. Therefore, the previous user can transfer the client to the new user without anxiety.

The “function implementable by the client”, at least part of which is made available by the function enabling unit of the client, is not particularly limited.

In cases where the communication system comprises a supply server capable of supplying a service (content) to the client in response to a request from the client, the “function” of the client requiring the authentication can be a function of processing the content supplied from the supply server (e.g. content displaying function).

For the above configuration, the client may be provided with a service supply request transmitting unit which transmits a service supply request (requesting the supply of a service) to the supply server when a “service supply judgment unit” judges that a service associated with the client has already been registered in a “service supply database”, and the function enabling unit of the client may be configured to switch the service supply request transmitting unit from a state prohibiting the transmission of the service supply request to a state allowing the transmission of the service supply request when the permission instruction is received from the server, as described below. With such a configuration, the above function of processing content supplied from the supply server can be made available in the client by the function enabling unit.

Preferably, the communication system comprises a supply server capable of supplying a service to the client. The client further includes: a service supply judgment unit which judges whether or not a service associated with the client has already been registered in a service supply database in which each service supplied by the supply server is registered while associating the service with each client to which the service should be supplied; and a service supply request transmitting unit which transmits a service supply request, requesting the supply of a service, to the supply server when the service supply judgment unit judges that a service associated with the client has already been registered in the service supply database. The function enabling unit of the client switches the service supply request transmitting unit from a state in which the transmission of the service supply request is prohibited to a state in which the transmission of the service supply request is allowed when the permission instruction is received from the server.

With the above configuration, the client is allowed to request the supply server to supply a service only when a service that should be supplied by the supply server to the client has already been registered. Therefore, it becomes possible to prevent the regular users from suffering losses from pay service billing, etc. while properly charging non-regular users using such pay services. By the elimination of unnecessary issuance of the service supply request to the supply server when there exists no service to be supplied from the supply server to the client, an extra processing load on the supply server due to the unnecessary issuance of the service supply requests can be prevented from occurring, which is highly advantageous especially when the supply server is configured to supply services to a plurality of clients.

In the above configuration, the method of judgment employed by the service supply judgment unit of the client judging whether or not a service associated with the client has already been registered in the service supply database) is not particularly limited.

The placement (location) of the service supply database is also not particularly limited, that is, the service supply database may either be placed with the client, the server or the supply server, or placed independently on a network connecting the client, the server and the supply server together.

Preferably, the server further includes: an inquiry search unit which searches the service supply database for a service associated with a client when a registration inquiry, for inquiring whether or not a service associated with the client has already been registered in the service supply database, is received from the client; and a search result transmitting unit which transmits result of the search by the inquiry search unit to the client transmitting the registration inquiry. The service supply judgment unit of the client makes the judgment on whether a service associated with the client has already been registered in the service supply database or not based on the search result received from the server after the transmission of the registration inquiry to the server.

With the above configuration, the client can make the judgment on whether a service associated with the client itself has already been registered in the service supply database or not only by transmitting the registration inquiry to the server and referring to the search result as the response to the registration inquiry.

Preferably, the server further includes a registration examination unit which determines whether to permit the registration of the authentication information, contained in the registration application transmitted from the client, in the authentication database by the information registering unit or not based on the authentication information. The information registering unit registers the authentication information contained in the registration application in the authentication database when the registration examination unit determines to permit the registration.

With the above configuration, the examination on whether to permit the information registering unit to register the authentication information (contained in the registration application transmitted from the client) in the authentication database or not can be executed by the registration examination unit, by which the authentication regarding the registration application transmitted from the client can be carried out under a prescribed condition.

In accordance with another aspect of the present invention, there is provided a server capable of communicating with a client and executing authentication for making at least part of a function implementable by the client available, comprising: an authentication judgment unit which judges whether or not authentication information on the client, contained in an authentication request transmitted from the client for requesting authentication of the client, has already been registered in an authentication database (in which authentication information to be used for authenticating the client is registered while associating the authentication information with the client) as authentication information on the client transmitting the authentication request; a permission instruction transmitting unit which transmits a permission instruction, representing permission for use of the fuinction, to the client transmitting the authentication request when the authentication judgment unit judges that the authentication information contained in the authentication request has already been registered in the authentication database; a registration request transmitting unit which transmits a registration request, requesting new registration in the authentication database, to the client transmitting the authentication request when the authentication judgment unit judges that the authentication information contained in the authentication request has not been registered in the authentication database; and an information registering unit which registers authentication information on the client, contained in a registration application transmitted from the client receiving the registration request from the registration request transmitting unit for applying for registration, in the authentication database as authentication information on the client transmitting the registration application. The permission instruction transmitting unit is configured to transmit the permission instruction to a client on which the registration of authentication information in the authentication database has been carried out by the information registering unit.

With the server configured as above, a part (server) of the communication system described above can be formed to achieve the aforementioned effects. The server may be provided with some or all of the units of the servers in the communication systems described above.

In accordance with another aspect of the present invention, there is provided a client capable of communicating with a server executing authentication for making at least part of a function implementable by the client available, comprising: an information input unit which lets a user input authentication information to be used for authenticating the client; an authentication request transmitting unit which transmits an authentication request for requesting authentication of the client, containing the authentication information inputted through the information input unit, to the server; a registration application transmitting unit which transmits a registration application for applying for registration of authentication information, containing authentication information inputted through the information input unit, to the server when a registration request for requesting new registration is received from the server receiving the authentication request transmitted by the authentication request transmitting unit; and a function enabling unit which switches an operational state of the client from a function unavailable state in which at least part of the function implementable by the client is unavailable to a function available state in which the fiction is available when a permission instruction representing permission for use of the function is received from the server receiving the authentication request transmitted by the authentication request transmitting unit or the registration application transmitted by the registration application transmitting unit.

With the client configured as above, a part (client) of the communication system described above can be formed to achieve the aforementioned effects. The client may be provided with some or all of the units of the clients in the communication systems described above.

In accordance with another aspect of the present invention, there is provided a computer program product comprising computer-readable instructions to be executed by a server, capable of communicating with a client and executing authentication for making at least part of a function implementable by the client available. The instructions case the server to: judge whether or not authentication information on the client, contained in an authentication request transmitted from the client for requesting authentication of the client, has already been registered in an authentication database (in which authentication information to be used for authenticating the client is registered while associating the authentication information with the client) as authentication information on the client transmitting the authentication request; to transmit a permission instruction, representing permission for use of the function, to the client transmitting the authentication request if it is judged that the authentication information contained in the authentication request has already been registered in the authentication database; to transmit a registration request, requesting new registration in the authentication database, to the client transmitting the authentication request if it is judged that the authentication information contained in the authentication request has not been registered in the authentication database; and to register authentication information on the client, contained in a registration application transmitted from the client receiving the registration request for applying for registration, in the authentication database as authentication information on the client transmitting the registration application. In this configuration, the permission instruction is transmitted to a client on which the registration of authentication information in the authentication database has been carried out by the information registering step.

The server controlled by the above computer program product is capable of forming a part (server) of the communication system described above to achieve the aforementioned effects. The computer program product may be configured to cause the server to function as some or all of the units of the servers in the communication systems described above.

In accordance with another aspect of the present invention, there is provided a computer program product comprising computer-readable instructions to be executed by a client, capable of communicating with a server executing authentication for making at least part of a function implementable by the client available. The instructions cause the client to: let a user input authentication information to be used for authenticating the client; to transmit an authentication request for requesting authentication of the client, containing the authentication information, to the server; to transmit a registration application for applying for registration of authentication information, containing authentication information, to the server if a registration request for requesting new registration is received from the server receiving the authentication request; and to switch an operational state of the client from a function unavailable state in which at least part of the function implementable by the client is unavailable to a function available state in which the function is available if a permission instruction representing permission for use of the function is received from the server receiving the authentication request or the registration application.

The client controlled by the above computer program product is capable of forming a part (client) of the communication system described above to achieve the aforementioned effects. The computer program product may be configured to cause the client to function as some or all of the units of the clients in the communication systems described above.

Illustrative Embodiments

Referring now to the drawings, a description will be given in detail of a preferred embodiment in accordance with the present invention.

(1) Overall Composition of Communication System

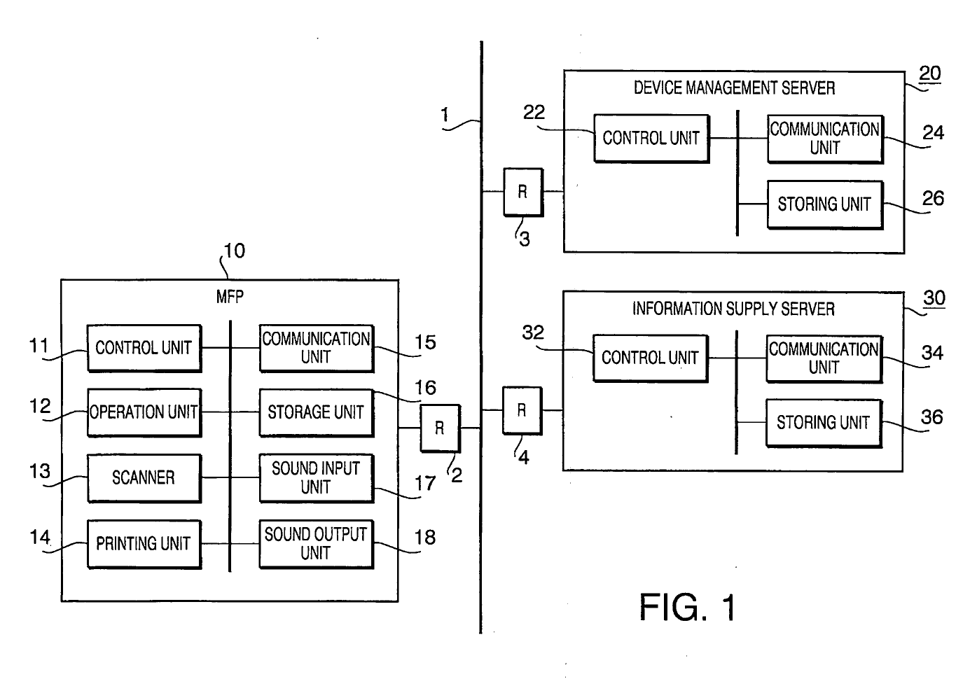

FIG. 1 is a block diagram showing the overall composition of a communication system in accordance with an embodiment of the present invention. As shown in FIG. 1, the communication system includes an MFP (Multi Function Peripheral) 10, a device management server 20 (hereinafter simply referred to as a “management server 20”), an information supply server 30 (hereinafter simply referred to as a “supply server 30”), etc. which are connected together by a network 1 to communicated data with one another. Incidentally, the MFP 10, the management server 20 and the supply server 30 are connected to the network 1 via routers 2, 3 and 4 (R: well-known broadband routers), respectively.

The MFP 10 includes a control unit 11, an operation unit 12, a scanner 13, a printing unit 14, a communication unit 15, a storage unit 16, a sound input unit 17 and a sound output unit 18. The control unit 11, including a CPU (Central Processing Unit), a ROM (Read Only Memory) and a RAM (Random Access Memory), controls the whole MFP 10 according to a program stored in the ROM.

The operation unit 12 is a unit configured as a user interface including a display, a copy key, a scanner key, a FAX key, a service key, a setting key, directional keys (up, down, right, left), an OK key, a cancel key, etc. The scanner 13 is an input device for implementing the scanner function. The scanner 13 reads an image printed on a sheet-like print medium (e.g. paper) and generates image data representing the image. The printing unit 14 is an output device for implementing the printer function. The printing unit 14 prints an image represented by image data on a sheet-like print medium (e.g. paper).

The communication unit 15 is a unit for executing processes for connecting the MFP 10 with the network 1 and communicating data via the network 1. The storage unit 16, including an unshown NVRAM (NonVolatile RAM), is configured to store data in the NVRAM. The sound input unit 17 receives sound with a microphone of an unshown handset of the MFP 10 and generates sound data (e.g. PCM data) representing the sound. The sound output unit 18 outputs sound represented by sound data (e.g. PCM data) from a speaker of the unshown handset or from an unshown speaker of the body of the MFP 10.

The management server 20 includes a control unit 22, a communication unit 24 and a storage unit 26. The control unit 22, including a CPU, a ROM and a RAM, controls the whole management server 20 according to a program stored in the ROM. The communication unit 24 is a unit for executing processes for connecting the management server 20 with the network 1 and communicating data via the network 1. The storage unit 26, including an unshown hard disk, is configured to store data in the hard disk. The supply server 30 includes a control unit 32, a communication unit 34 and a storage unit 36. The control unit 32, including a CPU, a ROM and a RAM, controls the whole supply server 30 according to a program stored in the ROM. Incidentally, the control unit 32 of the supply server 30, having far higher performance than the control unit 11 of the MFP 10, is capable of executing processes that are difficult for the control unit 11.

The communication unit 34 is a unit for executing processes for connecting the supply server 30 with the network 1 and communicating data via the network 1. The storage unit 36, including an unshown hard disk, is configured to store data in the hard disk.

(2) Processes Executed by MFP 10

In the following, processes executed by the control unit 11 of the MFP 10 will be described in detail.

(2-1) Startup Process

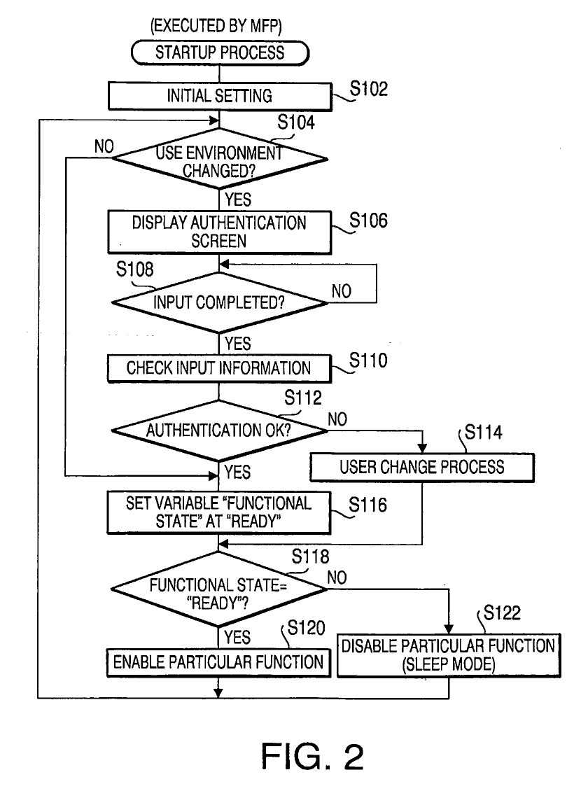

First, a startup process which is executed by the control unit 11 will be explained referring to FIG. 2. The startup process is executed upon startup of the MFP 10.

At the start of the startup process, the control unit 11 makes the initial setting of parameters of the MFP 10 (S102). In this step, the initial setting is made regarding parameters necessary for the MFP 10 to implement data communication via the network 1. Specifically, in a setting in which various parameters have already been assigned statically (in a fixed manner) to the MFP 10, such parameters are set to the MFP 10 (communication unit 15) as the parameters used for implementing the data communication via the network 1. On the other hand, in a setting in which various parameters are assigned dynamically to the MFP 10 (in cooperation with an unshown DHCP (Dynamic Host Configuration Protocol) server), the MFP 10 is supplied with such parameters from the DHCP server and sets the parameters to itself as the parameters necessary for implementing the data communication via the network 1. Here, the “various parameters” include an IP address assigned to the MFP 10, a default route (IP address of a default gateway server), a subnet mask, and an IP address assigned to a DNS (Domain Name System) server. Such parameters have previously been set to the DHCP server as parameters assignable to other network devices. Therefore, ranges of parameters that can be assigned by the DHCP server are dependent on the current settings of the DHCP server.

Subsequently, the control unit 11 checks whether or not use environment of the MFP 10 has changed compared to the previous startup (S104). In this embodiment, the MFP 10 has stored the various parameters before the initial setting of S102, that is, the various parameters that had been set to the MFP 10 at the previous startup (including an IP address of the DHCP server in the setting in which the parameters are assigned dynamically to the MFP 10) in the storage unit 16, and the control unit 11 makes the judgment (on whether the use environment of the MFP 10 has changed since the previous startup or not) by comparing one or more of the parameters stored in the storage unit 16 with corresponding parameters set in the step S102. For example, the control unit 11 may judge that the use environment of the MFP 10 has changed since the previous startup when the default route or the IP address of the DHCP server stored in the storage unit 16 at the previous startup is different from that set in the step S102. The control unit 11 may also judge that the use environment of the MFP 10 has changed when a range of parameters currently assignable by the DHCP server differs from the range of parameters set at the previous startup.

If the use environment has not changed (S104: No) the process advances to step S116 skipping steps S106-S114 which will be explained below.

If the use environment has changed (S104: YES), the control unit 11 displays an authentication screen (for performing authentication) on the display of the operation unit 12 (S106). In this embodiment, an authentication screen having input windows for receiving a user name and a password (as authentication information) inputted by the user is displayed on the display. After the authentication screen is displayed as above, the user can enter his/her user name and password in the input windows and thereafter perform an operation representing the completion of input through the operation unit 12 (e.g. pressing the OK key).

After displaying the authentication screen (S106), the control unit 11 waits for the user operation representing the completion of input (S108: NO). When the operation representing the completion of input is performed by the user (S108: YES), the control unit 11 checks whether the user name and password inputted by the user as above are proper information or not (S110). In this step, the control unit 11 judges that the user name and password inputted by the user (i.e. the user name and password in the input windows at the point of the user operation representing the completion of input (S108: YES)) are proper information if they coincide with a user name and a password previously registered and stored in the storage unit 16.

If the user name and password inputted by the user are improper information (S112: NO), the control unit 11 executes a user change process (S114) which will be explained later and thereafter advances to step S118.

On the other hand, if the user name and password inputted by the user are proper information (authentication OK) (S112: YES), the control unit 11 sets a variable “functional state” at a value representing “Ready” (S116) and thereafter advances to the step S118. The “functional state” is a variable which can be set at a value representing “Ready” or “Not Ready” (meaning that a particular function of the MFP 10 should be made available or not), as will be explained later. Thus, the particular function is made available in a subsequent step (S120) on the condition that the user name and password inputted by the user are proper information (S112: YES) or that the use environment of the MFP 10 has not changed since the previous startup (S104: NO).

After finishing the step S116 or S114, the control unit 11 checks whether the variable “functional state” is “Ready” or not (S118). If the variable “functional state” is “Ready” (S118: YES), the control unit 11 sets the MFP 10 in an operational state in which the “particular function” is available (S120). If the variable “functional state” is “Not. Ready” (S118: NO), the control unit 11 sets the MFP 10 in an operational state in which the particular function is unavailable (sleep mode) (S122) and thereafter returns to the step S104. In the step S104 executed thereafter, the control unit 11 judges that the use environment of the MFP 10 has changed (S104: YES) if a setting change has been made to the various parameters while the MFP 10 is ON. In this embodiment, the “particular function” which is made available or unavailable in S120 or S122 is a function of processing “content” supplied from the supply server 30 when a job is executed in a “device process” which will be explained later. The device process is activated only when the MFP 10 is in the operational state in which the particular function is available.

(2-2) User Change Process

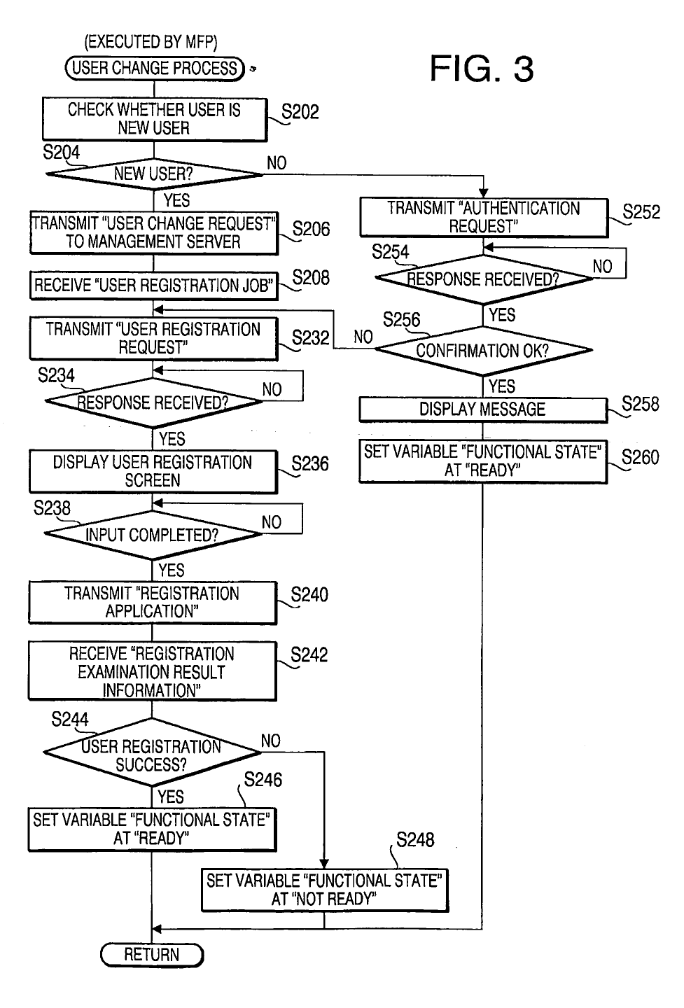

Next, the user change process executed by the control unit 11 in the step S114 of FIG. 2 will be explained referring to FIG. 3.

At the start of the user change process, the control unit 11 checks whether the user is a new user or not (S202). In this step, the control unit 11 displays a check screen (for inquiring of the user of the MFP 10 whether the user is a registered user or a yet unregistered user) on the display of the operation unit 12. After displaying the check screen, the control unit 11 waits until an operation representing “registered user” or “unregistered user” is performed by the user through the operation unit 12 and thereafter judges whether the user is a new user or not based on the user operation.

If the user is a new user (S204: YES), the control unit 11 transmits a user change request to the management server 20 (S206). The “user change request” is a request for changing registration information regarding the MFP 10 managed by the management server 20, as will be explained later. In the transmission of the user change request, a device ID for identifying the MFP 10 is attached to the request. From the management server 20 receiving the user change request, a “user registration job” (as a trigger for the execution of steps from S232 which will be explained later) is supplied as a response. Incidentally, the device ID is hereinafter assumed to be attached to every request transmitted from the MFP 10 unless otherwise noted.

Upon reception of the user registration job after the transmission of the user change request in S206 (S208), the control unit 11 transmits a user registration request to the management server 20 (S232). The “user registration request” is a request for changing (updating) the registration information (regarding the MFP 10, managed by the management server 20) according to information which will be inputted by the user in a subsequent step (S236), as will be explained later. From the management server 20 receiving the user registration request, a registration request (for prompting the user to specify registration information to be changed) is supplied as a response. Specifically, the registration request is a request that requests the control unit 11 to display a user registration screen, having input windows for entering authentication information for identifying the user (user name, password, address, full name, phone number, credit card number, etc.), on the display of the operation unit 12 as a screen for prompting the user to specify the registration information to be changed. Incidentally, the authentication information requested by the user registration screen is not restricted to the information listed above as long as the information is usable for the authentication.

After the transmission of the user registration request (S232), the control unit 11 waits until the response (registration request) is received from the management server 20 (S234: NO). Upon reception of the response (S234: YES), the control unit 11 displays the user registration screen on the display of the operation unit 12 according to the registration request as the response (S236). In this step, after the user registration screen is displayed on the display, the user inputs the authentication information to the user registration screen and thereafter performs an operation representing the completion of the input through the operation unit 12 (e.g. pressing the OK key).

After displaying the user registration screen (S236), the control unit 11 waits for the user operation representing the completion of input (S238: NO). When the operation representing the completion of input is performed by the user (S238: YES), the control unit 11 transmits a “registration application” (containing the authentication information inputted by the user to the user registration screen so far) to the management server 20 for requesting the registration of the authentication information in the management server 20 (S240). The management server 20 receiving the registration application executes a registration examination in regard to the user specified by the registration application and thereafter transmits registration examination result information (indicating whether the registration has been performed successfully or not) to the MFP 10 as a response, as will be explained later.

Subsequently, the control unit 11 receives the response (registration examination result information) from the management server 20 (S242) and checks whether the registration by the management server 20 was successful or not based on the registration examination result information (S244).

If the registration was successful (S244: YES), the control unit 11 sets the variable “functional state” at “Ready” (S246). If the registration was unsuccessful (S244: NO), the control unit 11 sets the variable “functional state” at “Not Ready” (S248). Thereafter, the user change process of FIG. 3 is ended (the process advances to the step S118 of FIG. 2).

In the aforementioned step S204, if the user is not a new user (S204: NO), the control unit 11 transmits an authentication request to the management server 20 (S252). The “authentication request” is a request that requests the management server 20 to judge whether the user (currently trying to use the particular function of the MFP 10) may be permitted to use the particular function or not in the case where the user name and password inputted in S108 of FIG. 2 by the user (who is not a new user (S204: NO)) is improper information (S112: NO). From the management server 20 receiving the authentication request, “confirmation information” (indicating that the MFP 10 as the sender of the authentication request has been confirmed as a “proper device”) is supplied as a response when the MFP 10 is confirmed by the management server 20 as a “proper device” (explained later). On the other hand, when the MFP 10 is not confirmed by the management server 20 as a proper device, a user registration job similar to the one received in the step S208 is supplied from the management server 20 as a response. Incidentally, the confirmation information is supplied from the management server 20 together with part of the authentication information (user name, etc.) managed by the management server 20.

After the transmission of the authentication request (S252), the control unit 11 waits until the response is received from the management server 20 (S254: NO). Upon reception of the response (S254: YES), the control unit 11 checks whether the MFP 10 has been confirmed by the management server 20 as a proper device or not based on the received response (S256). Specifically, the control unit 11 judges that the MFP 10 has been confirmed as a proper device if the response is the confirmation information.

If the MFP 10 has been confirmed as a proper device (S256: YES), the control unit 11 displays a message indicating that the confirmation (authentication) has been completed on the display of the operation unit 12 (S258), sets the variable “functional state” at “Ready” (S260), and ends the user change process of FIG. 3 (the process advances to the step S118 of FIG. 2).

On the other hand, if the MFP 10 has not been confirmed as a proper device (S256: NO), the process advances to the step S232.

(2-3) Device Process

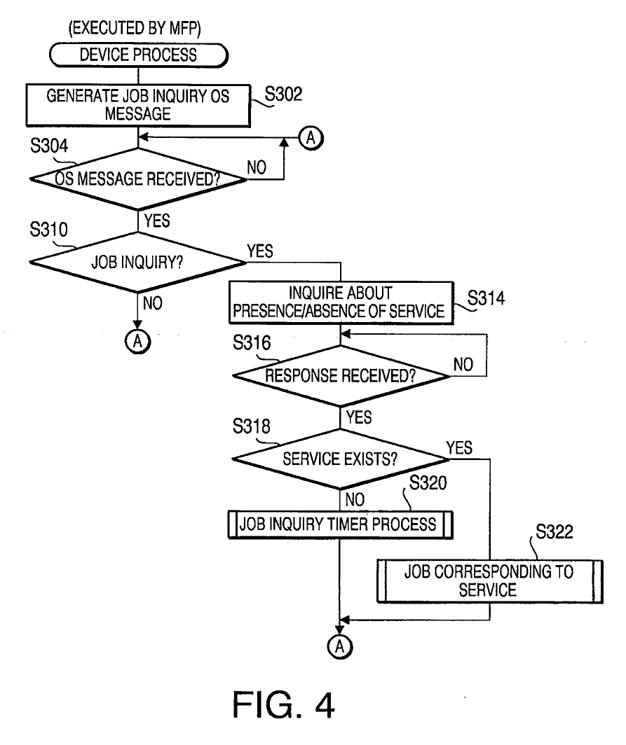

Next, the aforementioned device process which is executed by the control unit 11 will be explained referring to FIG. 4. The device process is executed repeatedly only when the MFP 10 is in the operational state in which the particular function is available (i.e. when the particular function has been made available in S120 of FIG. 2).

At the start of the device process, a “job inquiry OS message” is generated (S302). In this step, the job inquiry OS message is generated as an OS message to be handed over to subsequent steps of the device process.

When an OS message is received (generated) of (S304: YES), the control unit 11 checks whether the received OS message is the “job inquiry OS message” or not (S310). If the received OS message is not the job inquiry OS message (S310: NO), the process returns to the step S304.

On the other hand, if the received OS message is the job inquiry OS message (S310: YES), the control unit 11 inquires of the management server 20 about the presence/absence of a service that the MFP 10 can receive (S314). The inquiry is carried out in a state in which the device ID assigned to the MFP 10 can be identified. Incidentally, the management server 20 has stored a “service supply database”, in which the device ID of each client (e.g. MFP 10) has been registered associating the device ID with (the contents of) services to be supplied to the client and an address (URL) as the destination of access for requesting the service, as will be explained later. The management server 20 receiving the inquiry of S314 extracts a record associated with the device ID of the MFP 10 (sender of the inquiry) from the service supply database, and transmits registration information representing the contents of the extracted record (or indicating that no record can be extracted when no associated record can be extracted from the service supply database) to the MFP 10 as a response.

After the transmission of the inquiry (S314), the control unit 11 waits until the response is received from the management server 20 (S316: NO). Upon reception of the response (S316: YES), the control unit 11 checks whether there exists a service that the MFP 10 can receive or not based on the registration information as the response (S318). In this step, the control unit 11 judges that there exists a receivable service if the registration information (response) is not the information indicating that no record associated with the device ID of the MFP 10 can be extracted from the service supply database.

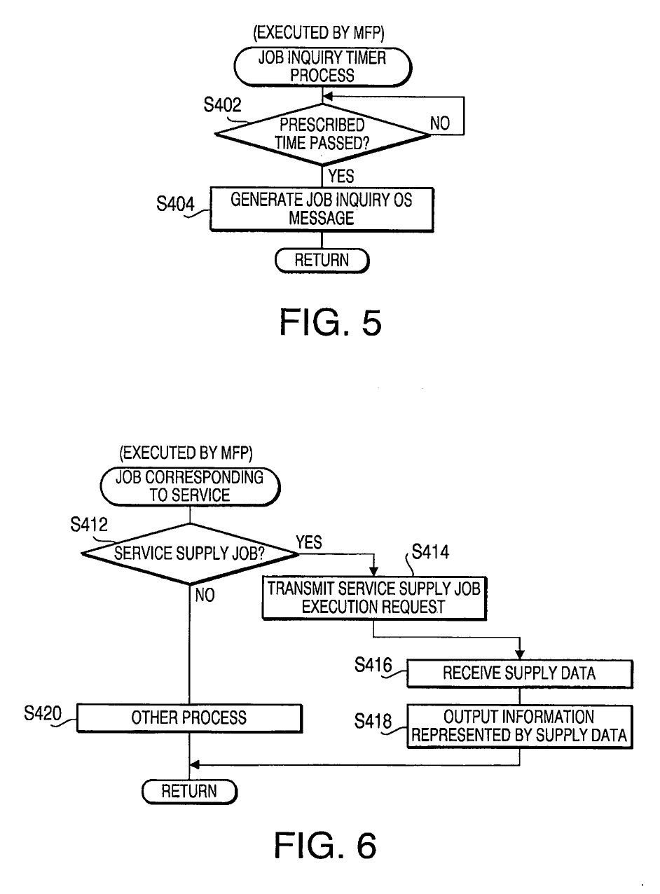

If there exists no service that the MFP 10 can receive (S318: NO), the control unit 11 sets a job inquiry timer (S320) and thereafter returns to the step S304. FIG. 5 is a flow chart showing a job inquiry timer process executed by the control unit 11 in the step S320 of FIG. 4. In the job inquiry timer process, the control unit 11 waits a prescribed time period (e.g. 10 minutes) (S402) and thereafter generates the next job inquiry OS message (S404).

On the other hand, if there exists a service that the MFP 10 can receive (S318: YES), the control unit 11 executes a process (job) corresponding to the service (S322) and thereafter returns to the step S304.

FIG. 6 is a flow chart showing the process (job) executed by the control unit 11 in the step S322 of FIG. 4. If the service indicated by the registration information (response) from the management server 20 is a service of a type in which the MFP 10 receives information supplied from the supply server 30 (S412: YES), the control unit 11 transmits a service supply job execution request to the address represented by the registration information received in S316 (the address of the supply server 30 in this embodiment) (S414). When “supply data” supplied from the destination of the access (supply server 30) in response to the service supply job execution request is received (S416), the control unit 11 lets the printing unit 14 output (print out) the information represented by the supply data (S418) and ends the process (job) of FIG. 6 (the process returns to the step S304 of FIG. 4). On the other hand, if the service indicated by the registration information (response) from the management server 20 is not a service of the type in which the MFP 10 receives information supplied from the supply server 30 (S412: NO), the control unit 11 executes a process corresponding to the service (other process) (S420) and ends the process (job) of FIG. 6 (the process returns to the step S304 of FIG. 4).

(3) Processes Executed by Management Server 20

In the following, processes executed by the control unit 22 of the management server 20 will be described in detail.

(3-1) Request Handling Process #1

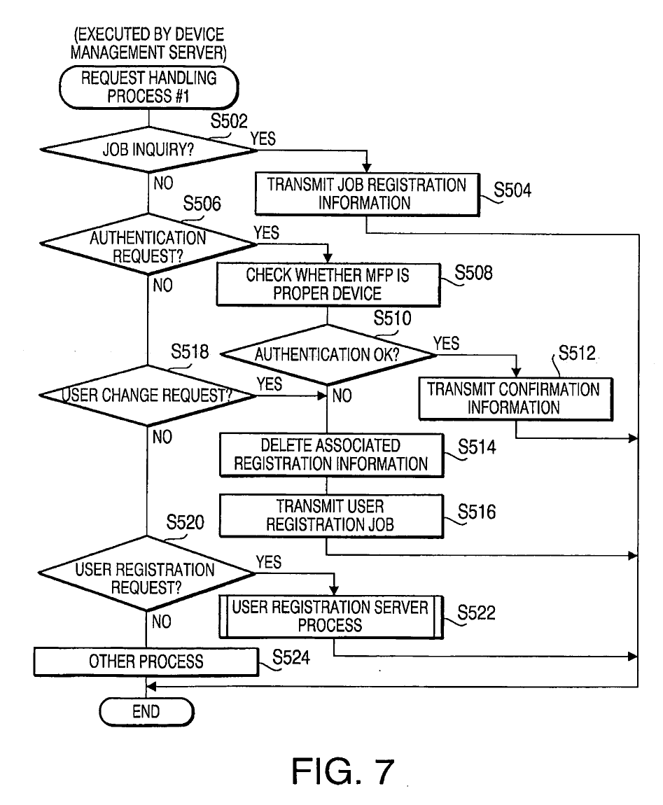

First, a request handling process #1 which is executed by the control unit 22 will be explained referring to FIG. 7. The request handling process #1 is executed upon reception of each request from the MFP 10.

At the start of the request handling process #1, the control unit 22 checks whether the request received from the MFP 10 prior to the startup of the request handling process #1 is a job inquiry or not (S502). The “job inquiry” is the request (inquiry) transmitted from the MFP 10 in the step S314 of FIG. 4.

If the request is a job inquiry (S502: YES), the control unit 22 transmits registration information (job registration information) to the MFP 10 (sender of the request) as a response (S504) and ends the request handling process #1 of FIG. 7. In the step S504, the control unit 22 searches the aforementioned service supply database for a record associated with the device ID specified by the request, generates information indicating the contents of the record found in the database (or indicating that no record can be found when no associated record can be found in the database) as the registration information, and transmits the generated registration information to the MFP 10 as the response. The registration information transmitted in this step is received by the MFP 10 in the step S316 of FIG. 4.

On the other hand, if the request is not a job inquiry (S502: NO), the control unit 22 checks whether the request is the authentication request or not (S506). The “authentication request” is the request transmitted from the MFP 10 in the step S252 of FIG. 3.

If the request is the authentication request (S506: YES), the control unit 22 checks whether the MFP 10 having the device ID specified by the authentication request (i.e. the MFP 10 as the sender of the authentication request) is a “proper device” or not (S508). In this embodiment, an authentication database, in which the device ID of each MFP (client) is registered while associating the device ID with authentication information, has been stored in the storage unit 26 of the management server 20. In the step S508, the control unit 22 judges that the MFP 10 as the sender of the authentication request is a proper device if authentication information (a user name and a password) which has been registered in the authentication database being associated with the device ID specified by the authentication request (or a value uniquely calculated from the user name, password, etc.) coincides with a user name and a password represented by the authentication request (or a value uniquely calculated from the user name, password, etc.). The check of S508 may also be carried out by an operator of the management server 20 by making a phone call to a phone number that has been registered in the authentication database being associated with the device ID specified by the authentication request. In this case, the operator may make the judgment on whether the MFP 10 as the sender of the authentication request is a proper device or not after receiving a response from the MFP 10 (or directly talking with the user of the MFP 10) and thereafter perform an operation specifying (inputting) the judgment.

If the MFP 10 as the sender of the authentication request is judged to be a proper device (S510: YES), the control unit 22 transmits the confirmation information (indicating that the MFP 10 has been confirmed as a proper device) to the MFP 10 (sender of the authentication request) as a response (S512) and ends the request handling process #1 of FIG. 7. The confirmation information transmitted in this step is received by the MFP 10 in the step S254 of FIG. 3.

On the other hand, if the MFP 10 as the sender of the authentication request is judged not to be a proper device (S510: NO), the control unit 22 deletes registration information associated with the device ID specified by the authentication request from the authentication database (S514). By the deletion of the registration information (associated with the device ID specified by the authentication request) from the authentication database, it becomes possible to newly register information (registration information) associated with the device ID in the authentication database in a subsequent step (S522).

After deleting the registration information associated with the device ID from the authentication database (S514), the control unit 22 transmits the user registration job to the MFP 10 (sender of the request) as a response (S516) and ends the request handling process #1 of FIG. 7. The “user registration job” transmitted in this step is received by the MFP 10 in the step S254 of FIG. 3.

In the aforementioned step S506, if the request is not the authentication request (S506: NO), the control unit 22 checks whether the request is the user change request or not (S518). The “user change request” is the request transmitted from the MFP 10 in the step S206 of FIG. 3.

If the request is the user change request (S518: YES), the process advances to the step S514. Specifically, the control unit 22 deletes registration information associated with the device ID specified by the user change request from the authentication database (S514), transmits the user registration job to the MFP 10 (sender of the request) as a response (S516), and ends the request handling process #1 of FIG. 7. The “user registration job” transmitted in this step is received by the MFP 10 in the step S208 of FIG. 3.

On the other hand, if the request is not the user change request (S518: NO), the control unit 22 checks whether the request is the user registration request or not (S520). The “user registration request” is the request transmitted from the MFP 10 in the step S232 of FIG. 3.

If the request is the user registration request (S520: YES), the control unit 22 executes a user registration server process (S522) which will be explained later, and ends the request handling process #1 of FIG. 7.

On the other hand, if the request is not the user registration request (S520: NO), the control unit 22 executes a process corresponding to the request (other process) (S524) and ends the request handling process #1 of FIG. 7.

(3-2) User Registration Server Process

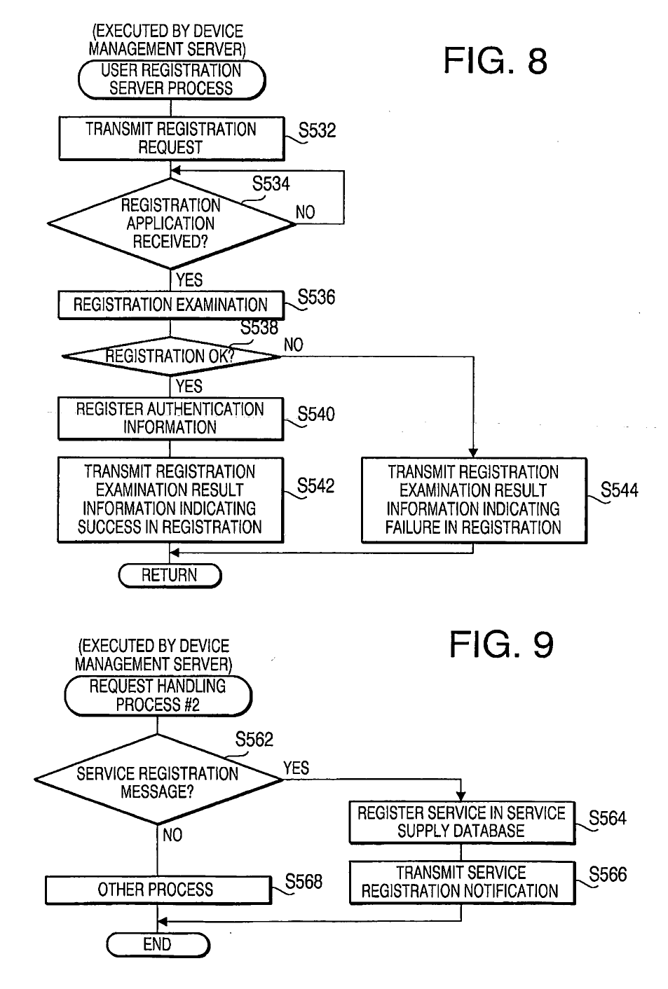

Next, the user registration server process which is executed by the control unit 22 in the step S522 of FIG. 7 will be explained referring to FIG. 8.

At the start of the user registration server process, the control unit 22 transmits the registration request to the MFP 10 (sender of the request) as a response to the user registration request (S532). The “registration request” transmitted in this step is received by the MFP 10 in the step S234 of FIG. 3. As explained before, the “registration request” is information for letting the MFP 10 display the user registration screen prompting the user to specify registration information to be changed. From the MFP 10 receiving the registration request, the registration application (representing the authentication information specified and inputted to the MFP 10 by the user) is supplied.

After the transmission of the registration request (S532), the control unit 22 waits until the registration application is received from the MFP 10 (S534: NO). Upon reception of the registration application (S534: YES), the control unit 22 executes the aforementioned registration examination for judging whether or not the authentication information may be registered according to the registration application (S536). In this step, the control unit 22 carries out the registration examination by searching a disallowance list (a data table stored in the storage unit 26 for registering information specifying users who should not be allowed to be registered) for particular information (full name, etc.) contained in the registration application and checking whether the particular information is found in the disallowance list or not.

When the result of the registration examination is affirmative, that is, when the particular information is not found in the disallowance list (S538: YES), the control unit 22 registers the authentication information represented by the registration application in the authentication database while associating the authentication information with the device ID attached to the request (registration application) (S540), transmits the registration examination result information, indicating success in the registration, to the MFP 10 (sender of the request) as a response (S542), and ends the user registration server process of FIG. 8. On the other hand, when the result of the registration examination is negative, that is, when the particular information is found in the disallowance list (S538: NO), the control unit 22 transmits the registration examination result information, indicating failure in the registration, to the MFP 10 (sender of the request) as a response (S544) and ends the user registration server process of FIG. 8. The registration examination result information transmitted in the step S542 or S544 is received by the MFP 10 in the step S242 of FIG. 3.

(3-3) Request Handling Process #2

Next, a request handling process #2 which is executed by the control unit 22 will be explained referring to FIG. 9. The request handling process #2 is executed upon reception of each request from the supply server 30.

At the start of the request handling process #2, the control unit 22 checks whether the request received from the supply server 30 prior to the startup of the request handling process #2 is a “service registration message” or not (S562). As will be explained later, the “service registration message” is a request transmitted from the supply server 30 for requesting the management server 20 to register a service to be supplied to a particular device in the aforementioned “service supply database” of the management server 20. In the service registration message, the device ID of the particular device, the contents of the service to be supplied to the particular device, and an address (URL) as the destination of access for requesting the service can be specified.

If the request is the service registration message (S562: YES), the control unit 22 registers the device ID, information indicating the contents of the service and the address specified by the service registration message in the service supply database while associating them with one another (S564), transmits a “service registration notification” (indicating that the registration has been completed as above) to the supply server 30 (sender of the request) as a response (S566), and ends the request handling process #2 of FIG. 9.

On the other hand, if the request is not the service registration message (S562: NO), the control unit 22 executes a process corresponding to the request (other process) (S568) and ends the request handling process #2 of FIG. 9.

(4) Processes Executed by Supply Server 30

In the following, processes executed by the control unit 32 of the supply server 30 will be described in detail.

(4-1) Job Execution Process

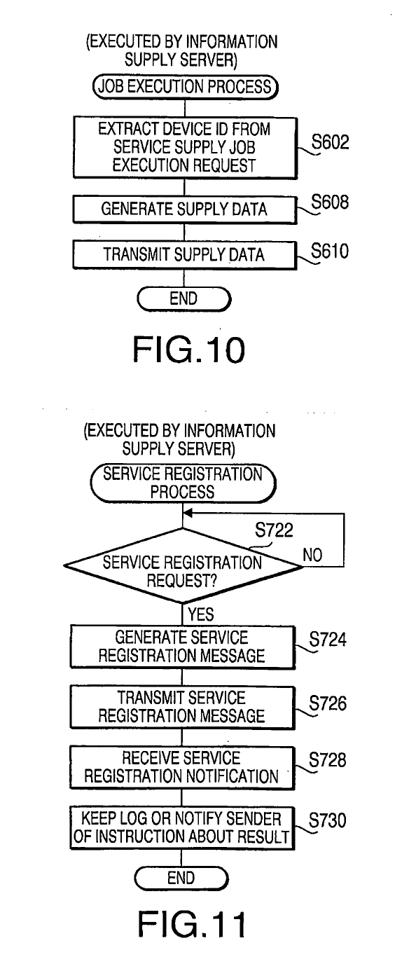

First, a job execution process which is executed by the control unit 32 will be explained referring to FIG. 10. The job execution process is executed upon each reception of the aforementioned service supply job execution request which is transmitted from the MFP 10 in the step S414 of FIG. 6.

At the start of the job execution process, the control unit 32 acquires the device ID that is specified by the service supply job execution request received prior to the startup of the job execution process (S602) and generates the “supply data” to be supplied to the MFP 10 (sender of the service supply job execution request) (S608).

After generating the supply data (S608), the control unit 32 transmits the supply data to the MFP 10 (sender of the service supply job execution request) (S610) and ends the job execution process of FIG. 10. The supply data transmitted in the step S610 is received by the MFP 10 in the step S416 of FIG. 6.

(4-2) Service Registration Process

Next, a service registration process which is executed by the control unit 32 will be explained referring to FIG. 11. The service registration process is started when an operation (input) to the supply server 30 is performed by a user or when an instruction from outside is received by the supply server 30. Incidentally, the “instruction from outside” is transmitted from a network device capable of communicating data with the supply server 30.

At the start of the service registration process, the control unit 32 checks whether the operation or instruction received prior to the startup of the service registration process is a “service registration request” or not (S722). The control unit 32 waits until the service registration request is received (S722: NO). If the operation or instruction is the service registration request (S722: YES), the control unit 32 generates the service registration message based on the service registration request (S724). The “service registration request” is an instruction (request) specifying the contents of a service to be supplied, the device ID of a device to which the service should be supplied, and an address (URL) as the destination of access for requesting the service. In this step, a message representing the service, the device ID and the address specified by the service registration request is generated as the service registration message.

After generating the service registration message (S724), the control unit 32 transmits the service registration message to the management server 20 (S726). The service registration message transmitted in this step is received by the management server 20 as a request in the step S562 of FIG. 9. The management server 20 receiving the request carries out the aforementioned registration of the service based on the service registration message (S564) and sends back the service registration notification (indicating that the service registration has been completed) to the supply server 30 as the response.

After transmitting the service registration message (S726), when the service registration notification transmitted from the management server 20 as the response is received (S728), the control unit 32 keeps a log indicating that the registration of the service has been completed by the management server 20 (enters a record in the log stored in the storage unit 36) or notifies the device as the sender of the instruction (received prior to the startup of the service registration process) that the service registration has been completed (S730) and ends the service registration process of FIG. 11.

(5) Effects of Embodiment

In the communication system configured as above, when the management server 20 (control unit 22) receiving the authentication request from a client (MFP 10) (S506 in FIG. 7: YES) judges that the client is not a proper device based on the authentication request (S510: YES), the management server 20 requests new registration in the authentication database by transmitting the user registration job to the client (S516). In the user registration server process (FIG. 8, S522 in FIG. 7) executed by the management server 20 upon reception of the user registration request from the client receiving the user registration job, the authentication information regarding the client can be newly registered in the authentication database (S540 in FIG. 8).

On the client's (MFP's) side, even when the authentication information (contained in the authentication request transmitted to the management server 20) has not been registered in the authentication database yet, the registration of authentication information in the authentication database can be carried out in the ordinary authentication sequence between the MFP 10 and the management server 20. Thus, even when the user of the client (MFP 10) is not a “regular” user (a user who registered the authentication information existing in the authentication database), the user is allowed to use the function of the MFP 10 without the need of an extra procedure (via a different route) for applying for the registration. In this case, the function of the MFP 10 is used by the non-regular user by use of the new authentication information different from the original authentication information previously registered by the regular user, and thus the use of the function of the MFP 10 by the non-regular user does not infringe on benefits of the regular user.

By the above authentication scheme, a third party having no intention of illegal use is allowed to use the MWP's function of processing content supplied from the supply server 30 through the authentication by the management server 20, without infringing on benefits of the regular user.

In the startup process (FIG. 2) executed by the MFP 10, when the authentication information inputted by the user coincides with previously registered authentication information (S112: YES), the “particular fiction” is immediately made available without the need of communication with the management server 20 (S120), by which an authentication load on the management server 20 and a communication load (traffic) on the network 1 on each input of authentication information is reduced considerably. In cases where two or more clients (e.g. MFPs 10) are included in the communication system, the effect of load reduction multiplies as the number of clients increases.

In the user change process (FIG. 3) executed by the MFP 10, when the user registration job is received from the management server 20, the MFP 10 requests the user to input the authentication information again (S236, S238). By letting the user input the authentication information again, the user is allowed to register different authentication information (different from the authentication information previously inputted in S108 of FIG. 2) in the authentication database. Of course, the user may also input the same authentication information in the second input.

The MFP 10 is capable of performing the client authentication based on the authentication information each time its use environment changes (S104 in FIG. 2: YES), by executing the steps from S106 of FIG. 2.

In the request handling process #1 (FIG. 7) executed by the management server 20, when the user change request is received from a client (S518: YES), the management server 20 deletes registration information associated with the client (device ID) from the authentication database (S514), transmits the user registration job to the client (S516), and thereafter registers authentication information supplied from the client in the authentication database (S540 in FIG. 8). Thus, in cases where the user change request is received from the same client, the management server 20 can carry out the registration (of the authentication information supplied from the client in the authentication database) by updating the registration information associated with the client. Therefore, even when the user of the client does not know proper authentication information to be inputted (e.g. when the client has just been transferred to a new user), the “particular function” of the client can be implemented as before by the registration of new authentication information.

The MFP 10 inquires of the management server 20 whether a service to be supplied from the supply server 30 to the MFP 10 has been registered in the service supply database or not (S314 in FIG. 4). The MFP 10 is allowed to request the supply server 30 to supply a service (S414 in FIG. 6) only when a response indicating that a service that the MFP 10 can receive has already been registered in the service supply database is received from the management server 20 (S318 in FIG. 4: YES). Therefore, it becomes possible to prevent the regular users from suffering losses from pay service billing, etc. while properly charging non-regular users using such pay services. By the elimination of unnecessary issuance of the service supply request (service supply job execution request) to the supply server 30 when there exists no service to be supplied by the supply server 30 to the MFP 10, an extra processing load on the supply server 30 due to the unnecessary issuance of the service supply requests can be prevented from occurring, which is highly advantageous especially when the supply server 30 is configured to supply services to a plurality of clients.

(6) Modifications

While a description has been given above of a preferred embodiment in accordance with the present invention, the present invention is not to be restricted by the particular illustrative embodiment and a variety of modifications, design changes, etc. are possible without departing from the scope and spirit of the present invention described in the appended claims.

For example, while the management server 20 and the supply server 30 in the above embodiment are provided as separate servers that implement the authentication information management and the service supply in cooperation with each other, the management server 20 and the supply server 30 may also be integrated into a single server. It is also possible to configure the supply server 30 to implement some of the functions of the management server 20 or to configure the management server 20 to implement some of the functions of the supply server 30.

In the user change process (FIG. 3) in the above embodiment, the MFP 10 receiving the user registration job from the management server 20 (S208, S254) requests the user to input authentication information again (S236, S238) and transmits the inputted authentication information to the management server 20 (S240). However, the MFP 10 may also be configured to transmit the previously inputted authentication information (inputted in the step S108 of the startup process of FIG. 2) to the management server 20 in the step S240, instead of transmitting the authentication information inputted by the user again. In this configuration, the MFP 10 after receiving the response in S234 of FIG. 3 may immediately transmit the registration application, containing the authentication information previously inputted in S108, to the management server 20, without executing the steps S236 and S238.

While the MFP 10 in the above embodiment executes the steps from S106 of FIG. 2 only when the use environment of the MFP 10 has changed, the MFP 10 may be configured to execute the steps from S106 also when a prescribed operation for using the “particular fiction” is performed by the user of the MFP 10 through the operation unit 12. In this case, the client authentication based on the authentication information can be conducted each time the particular fiction is executed by the MFP 10.

While the MFP 10 in the above embodiment carries out the check on whether the use environment of the MFP 10 has changed or not (S104) by referring to one or more parameters regarding network settings, the MFP 10 may also be configured to refer to parameters other than those regarding network settings (e.g. phone number) in S104 as long as the parameters can indicate a change in the use environment.

While the management server 20 receiving the user change request from a client (S518: YES) in the request handling process #1 (FIG. 7) deletes registration information associated with the client (device ID) from the authentication database (S514), transmits the user registration job to the client (S516) and thereafter registers authentication information supplied from the client in the authentication database (S540 in FIG. 8) in the above embodiment, the management server 20 may also be configured to register each piece of authentication information supplied from the client as separate authentication information, without deleting the registration information associated with the client upon each reception of the user change request. In this case, authentication information regarding two or more users can be assigned to one client, by which each client can be shared by a plurality of users.

While the MFP's function of executing a job in the device process (FIGS. 4-6) is made available (S120 in FIG. 2) through the authentication by the management server 20 in the above embodiment, the “particular function” made available through the authentication is of course not restricted to such a fiction.

The startup process (FIG. 2) executed by the MFP 10 may also be configured to carry out the steps from S104 only at the startup of the MFP 10. In this case, the startup process ends when the step S120 or S122 is finished, without returning to the step S104.

What is claimed is:

1. A communication system in which at least part of a function implementable by a client is made available through authentication by a server, wherein:
the server includes:
an authentication judgment unit which judges whether or not authentication information on the client, contained in an authentication request transmitted from the client for requesting authentication of the client, has already been registered in an authentication database, in which authentication information to be used for authenticating the client is registered while associating the authentication information with the client, as authentication information on the client transmitting the authentication request;
a permission instruction transmitting unit which transmits a permission instruction, representing permission for use of the function, to the client transmitting the authentication request when the authentication judgment unit judges that the authentication information contained in the authentication request has already been registered in the authentication database;
a registration request transmitting unit which transmits a registration request, requesting new registration in the authentication database, to the client transmitting the authentication request when the authentication judgment unit judges that the authentication information contained in the authentication request has not been registered in the authentication database; and
an information registering unit which registers authentication information on the client, contained in a registration application transmitted from the client receiving the registration request from the registration request transmitting unit for applying for registration, in the authentication database as authentication information on the client transmitting the registration application, and
the permission instruction transmitting unit is configured to transmit the permission instruction to a client on which the registration of authentication information in the authentication database has been carried out by the information registering unit, and
the client includes:
an information input unit which lets a user input authentication information to be used for authenticating the client;
an authentication request transmitting unit which transmits the authentication request, containing the authentication information inputted through the information input unit, to the server;
a registration application transmitting unit which transmits the registration application, containing authentication information inputted through the information input unit, to the server when the registration request is received from the server receiving the authentication request transmitted by the authentication request transmitting unit; and
a function enabling unit which switches an operational state of the client from a function unavailable state in which at least part of the function implementable by the client is unavailable to a function available state in which the function is available when the permission instruction is received from the server receiving the authentication request transmitted by the authentication request transmitting unit or the registration application transmitted by the registration application transmitting unit.

2. The communication system according to claim 1, wherein:
the client further includes a coincidence judgment unit which judges whether or not the authentication information inputted through the information input unit coincides with previously registered authentication information, and
the authentication request transmitting unit of the client transmits the authentication request, containing the authentication information inputted through the information input unit, to the server when the coincidence judgment unit judges that the authentication information does not coincide with the previously registered authentication information, and
the function enabling unit of the client switches the operational state of the client to the function available state without the transmission of the authentication request by the authentication request transmitting unit when the coincidence judgment unit judges that the authentication information inputted through the information input unit coincides with the previously registered authentication information.

3. The communication system according to claim 2, wherein:
the information input unit of the client lets the user input authentication information again in the case where the coincidence judgment unit judges that the authentication information inputted through the information input unit does not coincide with the previously registered authentication information, and
the registration application transmitting unit of the client transmits the registration application, containing the authentication information inputted through the information input unit again, to the server.

4. The communication system according to claim 1, wherein the information input unit of the client lets the user input the authentication information when a prescribed setting of the client has been changed.

5. The communication system according to claim 1, wherein the information input unit of the client lets the user input the authentication information at startup of the client.

6. The communication system according to claim 1, wherein when authentication information on the client transmitting the registration application to-the-server in response to the registration request from the registration request transmitting unit has already- been registered in the authentication database at the point of reception of the registration application from the client, the information registering unit of the server updates the already registered authentication information into authentication information represented by the received registration application.

7. The communication system according to claim 1, wherein:
the communication system comprises a supply server capable of supplying a service to the client, and
the client further includes:
a service supply judgment unit which judges whether or not a service associated with the client has already been registered in a service supply database in which each service supplied by the supply server is registered while associating the service with each client to which the service should be supplied; and
a service supply request transmitting unit which transmits a service supply request, requesting the supply of a service, to the supply server when the service supply judgment unit judges that a service associated with the client has already been registered in the service supply database, and
the function enabling unit of the client switches the service supply request transmitting unit from a state in which the transmission of the service supply request is prohibited to a state in which the transmission of the service supply request is allowed when the permission instruction is received from the server.

8. The communication system according to claim 7, wherein:
the server further includes:
an inquiry search unit which searches the service supply database for a service associated with a client when a registration inquiry, for inquiring whether or not a service associated with the client has already been registered in the service supply database, is received from the client; and
a search result transmitting unit which transmits result of the search by the inquiry search unit to the client transmitting the registration inquiry, and
the service supply judgment unit of the client makes the judgment on whether a service associated with the client has already been registered in the service supply database or not based on the search result received from the server after the transmission of the registration inquiry to the server.

9. The communication system according to claim 1, wherein the server further includes a registration examination unit which determines whether to permit the registration of the authentication information, contained in the registration application transmitted from the client, in the authentication database by the information registering unit or not based on the authentication information, wherein:
the information registering unit registers the authentication information contained in the registration application in the authentication database when the registration examination unit determines to permit the registration.

10. A server capable of communicating with a client and executing authentication for making at least part of a function implementable by the client available, comprising:
an authentication judgment unit which judges whether or not authentication information on the client, contained in an authentication request transmitted from the client for requesting authentication of the client, has already been registered in an authentication database, in which authentication information to be used for authenticating the client is registered while associating the authentication information with the client, as authentication information on the client transmitting the authentication request;
a permission instruction transmitting unit which transmits a permission instruction, representing permission for use of the function, to the client transmitting the authentication request when the authentication judgment unit judges that the authentication information contained in the authentication request has already been registered in the authentication database;
a registration request transmitting unit which transmits a registration request, requesting new registration in the authentication database, to the client transmitting the authentication request when the authentication judgment unit judges that the authentication information contained in the authentication request has not been registered in the authentication database; and
an information registering unit which registers authentication information on the client, contained in a registration application transmitted from the client receiving the registration request from the registration request transmitting unit for applying for registration, in the authentication database as authentication information on the client transmitting the registration application, wherein:
the permission instruction transmitting unit is configured to transmit the permission instruction to. a client on which the registration of authentication information in the authentication database has been carried out by the information registering unit.

11. A client capable of communicating with a server executing authentication for making at least part of a function implementable by the client available, comprising:
an information input unit which lets a user input authentication information to be used for authenticating the client;
an authentication request transmitting unit which transmits an authentication request for requesting authentication of the client, containing the authentication information inputted through the information input unit, to the server;
a registration application transmitting unit which transmits a registration application for applying for registration of authentication information, containing authentication information inputted through the information input unit, to the server when a registration request for requesting new registration is received from the server receiving the authentication request transmitted by the authentication request transmitting unit; and
a function enabling unit which switches an operational state of the client from a function unavailable state in which at least part of the function implementable by the client is unavailable to a function available state in which the function is available when a permission instruction representing permission for use of the function is received from the server receiving the authentication request transmitted by the authentication request transmitting unit or the registration application transmitted by the registration application transmitting unit.

12. A computer program product comprising computer-readable instructions to be executed by a server, capable of communicating with a client and executing authentication for making at least part of a function implementable by the client available, the instructions causing the server to:
judge whether or not authentication information on the client, contained in an authentication request transmitted from the client for requesting authentication of the client, has already been registered in an authentication database, in which authentication information to be used for authenticating the client is registered while associating the authentication information with the client, as authentication information on the client transmitting the authentication request;
transmit a permission instruction, representing permission for use of the function, to the client transmitting the authentication request if it is judged that the authentication information contained in the authentication request has already been registered in the authentication database;
transmit a registration request, requesting new registration in the authentication database, to the client transmitting the authentication request if it is judged that the authentication information contained in the authentication request has not been registered in the authentication database; and
register authentication information on the client, contained in a registration application transmitted from the client receiving the registration request for applying for registration, in the authentication database as authentication information on the client transmitting the registration application, wherein:
the permission instruction is transmitted to a client on which the registration of authentication information in the authentication database has been carried out.

13. A computer program product comprising computer-readable instructions to be executed by a client, capable of communicating with a server executing authentication for making at least part of a function implementable by the client available, the instructions causing the client to:
let a user input authentication information to be used for authenticating the client;
transmit an authentication request for requesting authentication of the client, containing the authentication information, to the server;
transmit a registration application for applying for registration of authentication information, containing authentication information, to the server if a registration request for requesting new registration is received from the server receiving the authentication request; and
switch an operational state of the client from a function unavailable state in which at least part of the function implementable by the client is unavailable to a function available state in which the function is available if a permission instruction representing permission for use of the function is received from the server receiving the authentication request or the registration application.
